(19) United States
(12) Patent Application Publication
(10) Pub. No.: US 2003/0106219 A1
(43) Pub. Date: Jun. 12, 2003

(54) Multi-purpose shaver

(76) Inventor: Tung Yan Lau, Hong Kong (CN)

Correspondence Address: Mr. Eric Chan, 42 Pin Oaks Drive, Phoenixville, PA, 19460, US

(21) Appl. No.: 10/314,314

(22) Filed: Dec. 9, 2002

(30) Foreign Application Priority Data
Dec. 11, 2001 (CN) 01278035.9

(51) Int. Cl. B26B 19/10

(52) U.S. Cl. 30/43; 30/34.1; 30/29.5

(57) ABSTRACT

The present invention relates to a multi-purpose shaver which combines a moustache and beard shaver and a nasal hair trimmer in one casing. The multi-purpose shaver generally comprises a casing, a mini motor, a moustache and beard shaver and a nasal hair trimmer. The shaver rotary head can rotate in clockwise or anti-clockwise direction. If cleaning is desired, the shaver rotary head can be pulled out from the blade entrance of the shaver for cleaning. The moustache and beard shaver and the nasal hair trimmer each have a blade sheath. The invention is of simple and durable structure and is convenient to use, easy to clean and safe to use.

### BACKGROUND OF THE INVENTION

The present invention relates to a new multi-purpose shaver which combines a moustache and beard shaver and a nasal hair trimmer in one casing.

The available shavers in the marketplace mostly serve as either a moustache and beard shaver or a nasal hair trimmer. Even for those which can serve as both a moustache and beard shaver and a nasal hair trimmer, they can only do so by interchanging two blade heads. Therefore, it is inconvenient to use. In addition, the frequent changing of the blade heads will easily cause damage to the parts and fittings of the shaver, thus reducing its durability.

### BRIEF SUMMARY OF THE INVENTION

In view of the aforesaid disadvantages now present in the prior art, the present invention provides a new multi-purpose shaver which can serve as both a moustache and beard shaver and a nasal hair trimmer with only one rotary blade head.

To attain this, the present invention generally comprises a casing, a mini motor, a moustache and beard shaver and a nasal hair trimmer. The upper part of the casing has a tumbler inside, which is installed securely to one side of the casing through a spring. The connection point of the spring and the tumbler is connected to a mini motor through a drag link. On one side of the drag link, there is a tappet. The tappet is connected to a button on the casing. The shaver rotary blade head is installed along one side of the tumbler. The moustache and beard shaver and the nasal hair trimmer are located at the two ends of the shaver rotary blade head respectively. The middle part of the tumbler has a shaft bearing. At the connection of the tumbler and the shaft bearing, there is a locking device to lock the shaver rotary blade head. The locking device is connected to a pivot which is installed securely to one inside of the casing.

The shaver rotary blade head is connected to the tumbler removably.

The moustache and beard shaver and the nasal hair trimmer each have a blade sheath.

When the multi-purpose shaver is in normal use, the locking device will lock the shaver rotary blade head. The tumbler will be separated from the casing and will tighten the shaver rotary blade head. The spring will become relaxed. The mini motor will drive the tumbler and make the shaver work. When the multi-purpose shaver is not in use, by pressing the button on the casing, the button will drive the tappet to move forward. The tappet will set against the drag link, thus releasing the tumbler from tightening the shaver rotary blade head. The spring will be pressed tight. The locking device will be released and by then the shaver rotary blade head can rotate in clockwise or anti-clockwise direction. If cleaning is desired, the shaver rotary blade head can be pulled out from the blade entrance of the shaver for cleaning.

It is an object of the present invention to provide a new multi-purpose shaver which can serve as both a moustache and beard shaver and a nasal hair trimmer with only one rotary blade head, which is convenient to use, easy to clean and safe to use.

It is another object of the present invention to provide a new multi-purpose shaver which is of simple and durable structure.

It is a further object of the present invention to provide a new multi-purpose shaver which requires no changing of blade heads, thus overcoming the disadvantages of the prior art.

### BRIEF DESCRIPTION OF THE DRAWINGS

FIG. 1 shows the cross-sectional view of the multi-purpose shaver while in use.

FIG. 2 shows the cross-sectional view of the multi-purpose shaver when not in use.

### DETAILED DESCRIPTION OF THE INVENTION

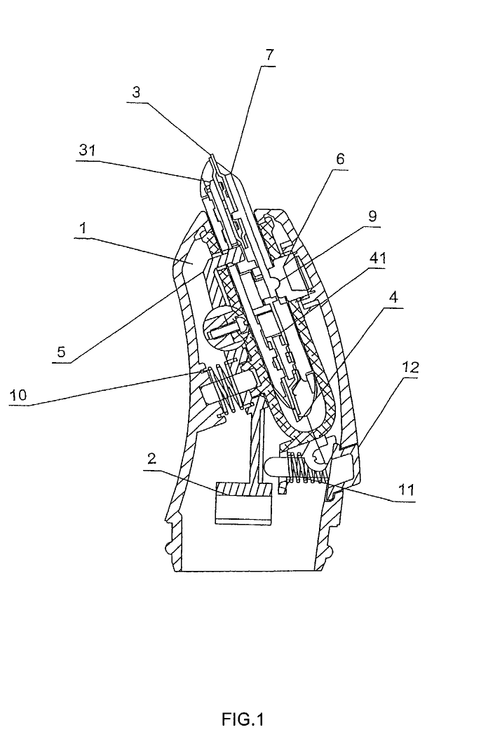

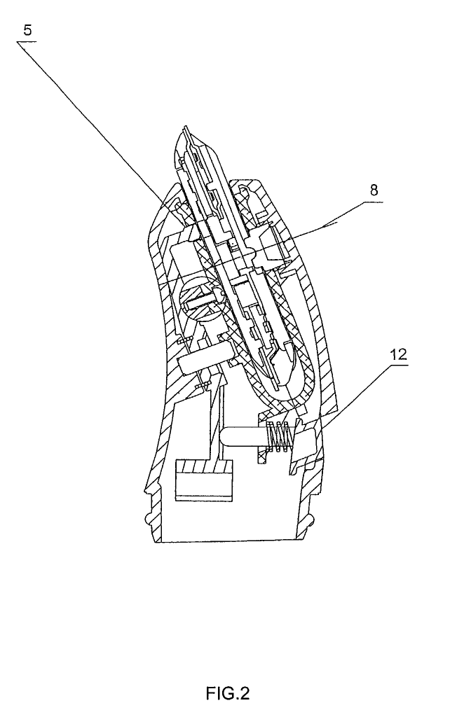

As illustrated in FIGS. 1 and 2, the multi-purpose shaver generally comprises a casing 1, a mini motor 2, a moustache and beard shaver 3, a nasal hair trimmer 4, a tumbler 5, a pivot 6, a shaver rotary blade head 7, a shaft bearing 8, a locking device 9, a spring 10, a tappet 11, a button 12, a blade sheath of the moustache and beard shaver 31 and a blade sheath of a nasal hair trimmer 41.

In the upper part of the casing 1, there is a tumbler 5, which is installed securely to one side of the casing 1 through a spring 10. The connection point of the spring 10 and the tumbler 5 is connected to the mini motor 2 through a drag link. On one side of the drag link, there is a tappet 11. The tappet 11 is connected to a button 12 on the casing 1. The shaver rotary blade head 7 is installed along one side of the tumbler 5. The moustache and beard shaver 3 and the nasal hair trimmer 4 are located at the two ends of the shaver rotary blade head 7 respectively. The middle part of the tumbler 5 has a shaft bearing 8. At the connection of the tumbler 5 and the shaft bearing 8, there is a locking device 9 to lock the shaver rotary blade head 7. The locking device 9 is connected to a pivot 6 which is installed securely to one side of the casing 1. The shaver rotary blade head 7 is connected to the tumbler 5 removably. The moustache and beard shaver 3 has a blade sheath 31 and the nasal hair trimmer 4 has a blade sheath 41.

As illustrated in FIG. 1, when the shaver rotary blade head 7 is in normal use, the locking device 9 will lock the shaver rotary blade head 7. The tumbler 5 will be separated from the casing 1 and will tighten the shaver rotary blade head 7. The spring 10 will become relaxed. The mini motor 2 will drive the tumbler 5 and make the shaver work.

As illustrated in FIG. 2, when the shaver rotary blade head 7 is not in use, by pressing the button 12 on the casing 1, the button 12 will drive the tappet 11 to move forward. The tappet 11 will set against the drag link, thus releasing the tumbler 5 from tightening the shaver rotary blade head 7. The spring 10 will be pressed tight. The locking device 9 will be released and by then the shaver rotary blade head 7 can rotate in clockwise or anti-clockwise direction. If cleaning is desired, the shaver rotary blade head 7 can be pulled out from the blade entrance of the shaver for cleaning.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A multi-purpose shaver comprising:
a casing, in the upper part of which there is a tumbler which is installed securely to one side of the casing through a spring.
a mini motor, to which the connection point of the spring and the tumbler is connected through a drag link and on one side of the drag link, there is a tappet which is connected to a button on the casing.
a moustache and beard shaver and a nasal hair trimmer which are located at the two ends of a shaver rotary blade head respectively and the shaver rotary blade head is installed along one side of the tumbler, and there is a shaft bearing in the middle part of the tumbler, and there is a locking device to lock the shaver rotary blade head at the connection of the tumbler and the shaft bearing, and the locking device is connected to a pivot which is installed securely to one side of the casing.

2. A multi-purpose shaver as in claim 1, wherein the shaver rotary blade head is connected to the tumbler removably.

3. A multi-purpose shaver as in claim 1, wherein the moustache and beard shaver and the nasal hair trimmer each have a blade sheath.
